(19) United States
(12) Patent Application Publication
(10) Pub. No.: US 2005/0068933 A1
(43) Pub. Date: Mar. 31, 2005

(54) Method and system for forwarding data units

(75) Inventors: Jani Kokkonen, Espoo (FI); Seppo Vesterinen, Oulunsalo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/965,729

(22) Filed: Oct. 18, 2004

Related U.S. Application Data
(63) Continuation of application No. PCT/FI03/00204, filed on Mar. 18, 2003.

(30) Foreign Application Priority Data
Apr. 24, 2002 (FI) 20020791

(51) Int. Cl. H04J 3/24; H04L 12/66; H04L 12/28; H04L 12/56

(52) U.S. Cl. 370/349; 370/352; 370/401

(57) ABSTRACT

A method and system for forwarding data units in a communications system, that comprises: ingress routers (901) capable of forwarding data units and containing a Forwarding Equivalence Class table (911) that contains mapping information, intermediate routers (905, 907, 909) capable of forwarding data units, egress routers (903) capable of forwarding data and containing a Forwarding Equivalence Class table (919) that contains mapping information. The method comprising the steps of: assigning a first label on data unit and a second label on data unit based on mapping information, sending data unit in to egress router via one or more intermediate router (905, 907, 909), receiving (903) data unit, identifying data unit based on mapping information on Forwarding Equivalence Class table (919) and based on second label. The method further comprises the steps of: creating a Forwarding Equivalence Class for radio access network specific data units; and storing information about Forwarding Equivalence Class in Forwarding Equivalence class table (FEC).

The field of the invention relates to a communication system where transport level user data packets are encapsulated. In particular, the present invention relates to a novel and improved method and communications system for forwarding data units in a communications system, the system comprising: one or more ingress routers capable of forwarding data units and containing a Forwarding Equivalence Class table said Forwarding Equivalence Class table containing mapping information, one or more intermediate routers capable of forwarding data units, one or more egress routers capable of forwarding data and containing a Forwarding Equivalence Class table said Forwarding Equivalence Class table containing mapping information. The method to be implemented in the system comprises the steps of: said one or more ingress router assigning a first label on said data unit and a second label on said data unit based on said mapping information, said one or more ingress router sending said data unit in to said egress router via said one or more intermediate router, said one or more egress router receiving said data unit said one or more egress router identifying said received data unit based on said mapping information on said Forwarding Equivalence Class table and based on said second label.

### BACKGROUND OF THE INVENTION

The growth of mobile communications and the Internet have spurred innovation and new technology in these areas, where the requirements of the modern day user are becoming more demanding. The boundaries between the various ‘traditional’ networks are becoming increasingly blurred. Nowadays, there is a significant overlap between applications traditionally in the telecommunications domain, i.e. circuit-switched traffic (voice) and applications traditionally in the data communication domain, i.e. packet-switched traffic (data). For instance, a mobile user forming part of the PLMN (Public Land Mobile Network) can now retrieve data from the Internet.

At present, there is a transition from second generation radio networks to third generation (3G) systems. Second generation mobile networks included the GSM system that made use of a combination of FDMA (Frequency division Multiple Access) and TDMA (Time Division Multiple Access), i.e. the allocated frequency spectrum is divided into frequency channels where each frequency channel carries eight TDMA channels. However, GSM (Global System for Mobile Communication) remains a circuit-switched technology where a communication channel will be dedicated to a user for the duration of the call. In contrast data communications, for example over the Internet, is performed by transferring data packets through a network where data is of a ‘bursty’ nature. A packet-switched network is preferred for data communications where a channel can be released immediately after packets are transmitted allowing more efficient resource usage, for example by statistical multiplexing where many users can share a communications channel.

The two basic approaches to packet-switching are well known:

i) “Connection-oriented” where during an initial phase a ‘virtual circuit’ is first established between two end-users (analogous to a standard voice circuit) and then packet data is transmitted down this pipe. An example is the X.25 network used for public packet data networks and ATM virtual circuits or ATM virtual paths.

ii) “Connection-less” also known as datagram switching or a “best-effort network”. An example of this approach is the Internet, which uses a datagram service where at each node (or router) the IP packet header is examined and the packet is routed to another intermediate node that is closer to the recipient. Thus, the packets are routed on a ‘hop-by-hop’ basis.

One of the differences between these two approaches is that the packet structure of the “connection-oriented” approach can use short headers, because the path of the envisaged data stream (virtual circuit) has already been established. In contrast, the data packets for the connection-less approach can arrive at the receiver in any order and each packet is treated as a ‘self-contained’ entity and therefore the header needs to carry full information about the intended recipient.

One of the aims of the present invention is to alleviate the processing overhead incurred when using MPLS or GTP to route packets through the core network.

UMTS

FIG. 1 shows the overall system structure of IMT-2000. UMTS (Universal Mobile Telecommunications System) is the European vision for 3G. The IMT-2000 (International Mobile Telecommunications) is an attempt by the ITU (International Telecommunication Union) to standardize certain functional elements and interfaces of 3G systems. The terms UMTS and IMT-2000 are often used interchangeably in relation to 3G systems. A MT (Mobile Terminal) 10 communicates with the RAN (Radio Access Network) 12 over the UNI (User-Network Interface) 18. The RAN 12 communicates with the CN (Core Network) 14 over the RAN-CN interface 20 which is also called Iu-interface. At the highest level, the CN 14 communicates with any other external networks 16 over the NNI (Network-Network Interface) 22. More generally, UMTS is concerned with the RAN 12 and CN 14 elements shown in FIG. 1, where the RAN-CN interface that connects these two elements is known as the ‘Iu interface’.

FIG. 2 shows the UTRAN (UMTS Terrestrial Radio Access Network) network that is composed of a node B often referred to as BTS or BS 203 and a RNC (Radio Network Controller) 201. The RNC is an equivalent to a BSC (Base Station controller) in the GSM hierarchy. The intention of UTRAN is to provide a flexible radio interface that is operable under a variety of conditions such as indoor and/or mobile use. Usually the radio interface is implemented using WCDMA (Wideband—Code Division Multiple Access) implementation. Furthermore, the CN (Core Network) is concerned with the control and routing operations of the backbone network.

FIG. 4 is a representation of the UMTS R99 architecture, which shows the core network as comprising two domains divided by the horizontal dotted line X-X. The domain below line X-X indicates a circuit switched network, whereas the upper domain shows a packet switched network. In practice this might be implemented as a GSM network overlaid with a GPRS network. Furthermore, the portion of FIG. 4 to the left of the vertical dotted line Y-Y indicates the RAN (Radio Access Network). The portion between the two vertical dotted lines Y-Y and Z-Z is the Core Network CN also depicted in FIG. 1. The portion to the right of vertical dotted line ZZ indicates the external networks, where for the circuit-switched domain this might be a connection to the PSTN and for the packet-switched domain this might be a PDN (Packet Data Network) such as the Internet.

FIG. 4 also shows the various interfaces that have been defined for UMTS. More importantly, two interfaces are defined for the RAN of the UMTS model, these are the:

Iu-CS interface, which connects the RNC to the circuit-switched domain, in particular to a Mobile Switching Center MSC,

IU-PS interface connects the RNC to the packet-switched domain. IU-PS interface connects RNC in particular to a Serving GPRS Support Node SGSN.

In FIG. 4 the GSN's (GPRS Support Nodes) may be interconnected to form the core network with privately addressable space between the GGSN and SGSN (Gn interface) of a given PLMN (Public Land Mobile Network). The GSN's communicate using an IP-based GPRS backbone network where the GSN's encapsulate the external PDN (Packet Data Network) packets and use GTP (GPRS Tunneling Protocol) to tunnel these packets through the core network. Tunneling is the act of transporting protocols foreign to an intermediate network by encapsulating the data packets on entry and decapsulating on exit from the intermediate network, so that the encapsulated foreign protocol appears transparent to the intermediate network.

GTP (GPRS Tunneling Protocol) is used between GSN nodes in the core network and is defined for the Gn interface depicted in FIG. 4. Furthermore, GTP is defined for both signalling and data transfer procedures. GTP specifies a tunnel and management protocol in the signalling plane. Signalling is used to set up a context as well as create, modify and delete tunnels. In the transmission plane, GTP uses a tunnelling mechanism to carry user data packets.

MPLS

MPLS (Multiprotocol Label Switching) is a packet forwarding technique standardised by the IETF (Internet Engineering Task Force). MPLS uses labels to make forwarding decisions at the network nodes. Traditionally MPLS has been used to transfer only IP-data or IP-packets. More generally, short labels also known as shim headers are assigned to data packets that provide information as to the manner in which they, i.e the packets, should be forwarded through the network.

FIG. 3 shows Radio Network Gateway unit 301 RNGW that functions as a contact point between the UMTS radio network in question and with other networks, e.g. a GSM network. The whole radio network depicted in FIG. 3 is divided into control plane and user plane. The control plane comprises at least Radio Network Gateway unit 301 RNGW, Radio Network Access Server RNAS 307 and one or several Internet Protocol Base Stations IPBTS 303 and 305. One or several Mobile Stations MS 311 are connected to these Internet Protocol Base Stations IPBTS 303 and 305 over radio interface 313 and 315. The user plane comprises at least the Radio Network Gateway unit 301 RNGW, one or several network nodes R 309 and the parts of the Internet Protocol Base Stations IPBTS 303 and 305 that do serve the user and exchange user message.

In a conventional IP network at the network layer, routing of packets is performed on a hop-by-hop basis where the IP network header of each packet is analysed and routed to the next router depending on routing tables. This requires processing of route calculation and processing of the packet header at each node of the network. In contrast, this processing is only performed once at the entrance node of the MPLS network known as the ingress node. The ingress node examines the label and assigns the packet to a stream or path. MPLS is also useful when a certain QoS (Quality of Service) needs to be established. In MPLS, the possible forwarding options in a network domain are partitioned into Forwarding Equivalency Classes FECs. For example, all the packets destined for a given egress node and requiring the same QoS may belong to the same FEC. Information about the fact to which FEC a certain packet belongs to is stored in a Forwarding Equivalency Class table. This is a memory that stores information about several FECs.

Packet forwarding is done based on labels. These labels are assigned when the packets enter into the network. Labels are on top (front) of the packets. MPLS nodes forward encapsulated packets/cells based on the label value and not on the IP header information. IP header information is not even needed.

Traffic engineering allows one to control the routing path taken through a network. This may be advantageous, for example, in a video or real-time application where it is possible to classify critical and normal traffic on a per-path basis. Broadly speaking, LSPs (Label Switched Paths) may be regarded as ‘virtual pipes’ (i.e. connection-orientated) or independent paths that may be set up in an MPLS network. Thus each LSP will have a series of LSR's (Label Switched Routers, see FIG. 3, R, 309) that work together to perform MPLS operations on a packet stream. Therefore, packets entering a path at an ingress node might be encapsulated into a FEC and switched across a network to the egress router without being touched by the intermediate nodes at the IP network level.

In MPLS, traffic aggregation is concerned with binding a single label having a specific FEC (Forwarding Equivalence Class) to a union of flows with the same FEC, where a flow has the same MPLS label. On the other hand the procedure of binding a single label to a union of FECs which union is itself a FEC (within some domain), and the procedure of applying that label to all traffic in the union, is known as aggregation. Further, it is possible to take advantage of different label granularities, the coarsest being where a set of FEC's is aggregated into a single FEC and the finest being where no aggregation takes place. Traffic aggregation reduces the number of labels needed to handle a particular set of packets, which also reduces the LDP (Label Distribution Protocol) control traffic. Broadly speaking, traffic aggregation may be done in two ways, i.e. by label merging and by label stacks.

Each of the intermediate nodes of an MPLS network uses the label of the incoming packet to determine its next hop and also performs “label swapping” by replacing the incoming label with a new outgoing label that identifies the respective FEC for the downstream node. The label swapping maps corresponding to the FEC are established using standard protocols such as RSVP (Resource Reservation Protocol) or LDP (Routing Label Distribution Protocol). This type of label-based forwarding technique reduces the processing overhead required for routing at the intermediate nodes, thereby improving packet forwarding performance and scalability. Furthermore, the label swapping process used by MPLS creates multipoint-to-point packet forwarding trees in contrast to a routing mesh in a conventional network based on a similar paradigm (i.e. ATM).

FIG. 5 shows the structure of a single label. The fields are explained below:

Label 570: The actual assigned label value (20 bits).

EXP 572: The experimental bits used to identify a required QoS (3 bits).

S 574: The stack bit is set if the particular label is at the bottom of the stack (1 bit).

TTL 576: Time to Live is an 8-bit field used in IP to specify how many more hops a packet can travel before being discarded or returned, i.e. the maximum time the datagram is allowed to remain in the network.

Generally these labels can be used over Ethernet, 802.3, PPP links, Frame Relay, ATM PVSs, etc.

For each data packet in the MPLS environment, a label may be assigned after the data link layer (i.e. layer 2) header but before any network layer (i.e. layer 3) header. Each user packet can carry a plurality of labels where a LIFO (Last In First Out) label stack may exist. At an intermediate node, the forwarding decision is based on the label at the top of the stack for each packet. Apart from the ‘swapping’ operation, each node (i.e. router) in an LSP is also normally able to perform push and pop operations for adding and removing labels respectively from the top of the stack. The swap operation simply replaces the label at the top of the stack with a new label (i.e. corresponding to the FEC of the downstream node).

Label Switching Router (LSR) can be an ATM switch or a router. Edge-LSR do label imposition and label removal. Label imposition is performed where the packet enters the MPLS network. Label removal is performed where the packet leaves the MPLS network. All LSRs use existing IP routing protocols to exchange routing information. All LSRs use a label distribution protocol. However not necessarily the same label distribution protocol is applied in all LSRs.

Label format and length depends on encapsulation. The encapsulation has to be planned and performed on negotiation between peers by using label distribution protocol. More than one label is allowed. Label stack: is an ordered set of labels. MPLS LSRs always forward packets based on the value of the label at the top of the stack.

IP RAN

There is a drive towards an all IP-based transport network where the RAN (Radio Access Network) is based on IP as well as the core network.

### SUMMARY OF THE INVENTION

The present invention concerns a novel and improved method for forwarding data units in a communications system. The inventive method for forwarding data units further comprises the steps of: creating a Forwarding Equivalence Class for radio access network specific data units; and storing information about said Forwarding Equivalence Class in Forwarding Equivalence class tables.

The present invention concerns a novel and improved communications system for forwarding data units, the system comprising: one or more ingress router containing: a Forwarding Equivalence Class table containing mapping information, an assigning means for assigning a first label and a second label on said data unit, and forwarding means for sending said data units in to said mobile communications system, said one or more ingress router containing one or more intermediate routers said intermediate routers comprising; forwarding means for forwarding data units within said communications system based on said first label, a Forwarding Equivalence Class table containing mapping information, said system comprising a second assigning means for assigning said second label based on the information in said Forwarding Equivalence Class table in said ingress router, an identifying means for identifying said data units in said egress routers based on information on said Forwarding Equivalence Class table and said second labels. Said first label is often referred to as a top label in MPLS art. Furthermore the term second label is known as a bottom label in the art.

The improved communications system for forwarding data units comprising further a classifier for creating Forwarding Equivalence Class for radio access network specific data units; and a memory for storing information about said Forwarding Equivalence Class in said Forwarding Equivalence class tables.

The target of the invention is to create an improved communications method and system for forwarding data units between different network nodes in a mobile communications system. The problem with the previous methods and systems has been that previously these methods have been unable to transfer MDC packets in MPLS network on the OSI model layer 2 e.g on ATM or frame-relay media.

A benefit of the invention is that according to the new method and system MDC packets can be transferred over ATM or frame relay media on the OSI model layer 2. This is done within architecture of IETF's PWE3 (Pseudo Wire Emulation Edge to Edge) working group. Previously it has not been possible to transfer MDC packets over ATM or frame relay media on the OSI model layer 2. However, MDC packets have been transferred over ATM between base station and RNC in Release 99 architecture. Currently in IP transport UTRAN solution, MDC frames are considered to be identified by UDP/IP address. With IPv6 this means 8+40 bytes overhead. By using MPLS encapsulation overhead is reduced to 4+4=8 bytes. That is significant improvement and helps to save scarce bandwidth in links that have narrow bandwidth in radio access networks.

Transport layer UDP/IP header compression for is not required with MDC over MPLS solution.

Generally UDP is not optimal solution for real time traffic transport, and therefore faster and more lightweigth solution should be preferred.

An MPLS label can be assigned to a user level IP packet after a MDC (Macro Diversity Combining) procedure performed at the ingress node. In the R99 UMTS network, the MDC happens in the RNC (Radio Network Controller) and therefore this concept is applicable to the uplink direction from the RNC onwards, i.e. in the Gp and Gn interfaces. On the other hand, if an IP RAN exists, then the MDC function may be pushed to the BTS (or Node B) and therefore the present invention is applicable to the whole UMTS network, which includes both the RAN and CN networks.

### BRIEF DESCRIPTION OF THE DRAWINGS

The accompanying drawings, which are included to provide a further understanding of the invention, constitute a part of this specification. These drawings illustrate embodiments of the invention and together with the description these drawings help to explain the principles of the invention. In the drawings:

FIG. 1 shows the overall system structure of IMT-2000 thus depicting the background art of the invention;

FIG. 2 shows the UMTS R99 architecture thus depicting the background art of the invention;

FIG. 3 shows MPLS (Multi Protocol Label Switching) in an IP RAN (Radio Access Network) domain thus depicting the background art of the invention;

FIG. 4 shows the network architectures of existing mobile networks thus depicting the background art of the invention;

FIG. 5 shows the structure of an MPLS label thus depicting the background art of the invention;

FIG. 6 shows the general encapsulation model for the inventive frames;

FIG. 7 shows the frame structure of the inventive frame;

FIG. 8 shows MDC frame encapsulation;

FIG. 9 shows first required label associations for MDC over MPLS transport in;

FIG. 10 showns a basic message transfer between serving and target CAN nodes;

FIG. 11 elaborates CAN internal operation;

FIG. 12 gives an general overview of MDC transport over MPLS; a cellular network comprising mobile IP architecture and

FIG. 13 a block diagram of the inventive communications system.

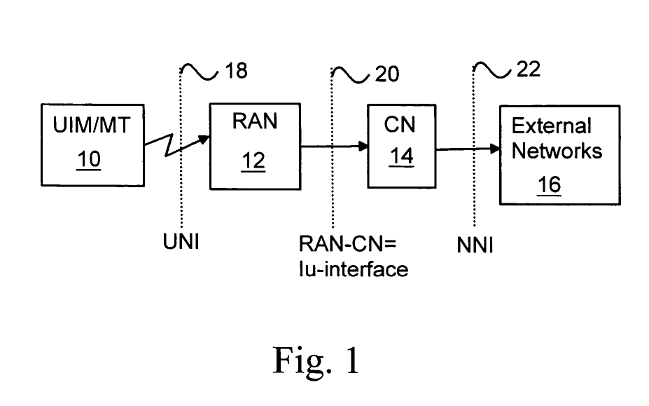

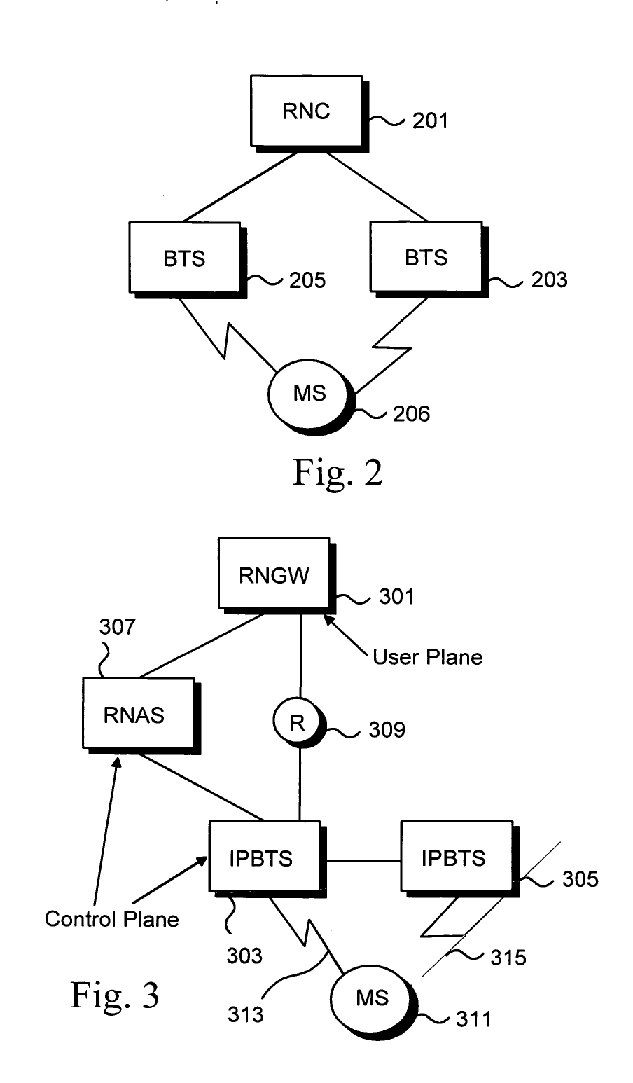

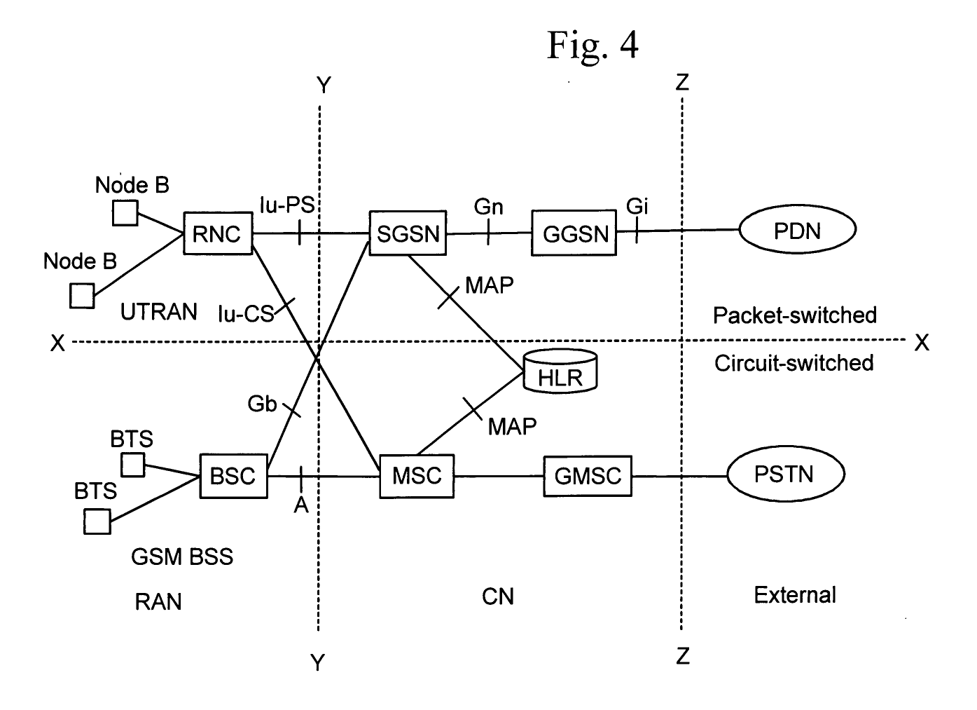

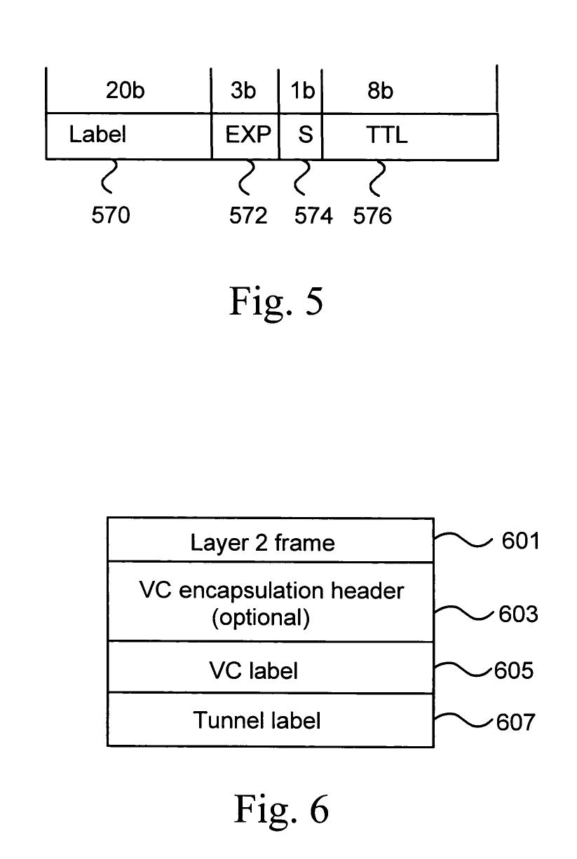

### DETAILED DESCRIPTION OF THE INVENTION

Reference will now be made in detail to the embodiments of the present invention, examples of which are illustrated in the accompanying drawings.

In the MPLS concept, the original idea has been to integrate the data link layer 2 of OSI model switching framework with network layer 3 of OSI model routing. However, generally MPLS is independent of any layer 2 or layer 3 technologies and thus, during the last years MPLS concept has been extended to include also those other technologies including internet protocol and Asynchronous Transfer Mode (ATM). Document [IETF, draft-martini-12circuit-trans-mpls-07.txt, July 2001,] describes how OSI layer 2 frames from several layer 2 technologies can be transmitted over MPLS. Said document describes that in MPLS transmission systems it is possible to transfer also Frame Relay, ATM, Ethernet, HDLC, PPP and CEM types of traffic. However this invention discloses an inventive way to transfer MDC traffic in MPLS transport network of a mobile communications systems, preferably in a UMTS network.

This invention is further extending the use of MPLS to include also MDC frames in RAN network. MDC means Macro Diversity Combining.

In MPLS layer 2 frame transport is based on MPLS label stacking concept that specifies emulated Virtual Circuit (VC) label in addition to normal Tunnel label in order to identify individual emulated virtual circuits within the Tunnel. The document IETF, draft-martini-12circuit-trans-mpls-07.txt, July 2001, specifies also special emulated VC encapsulation (also called control word), which contains information about encapsulated layer 2 PDU. Control word is required by several OSI model layer 2 technologies in order to properly emulate the corresponding layer 2 protocol. In document IETF, draft-martini-12circuit-encap-mpls-03.txt, July 2001, this optional encapsulation header is specified for ATM, Frame relay, Ethernet, HDLC and PPP frames.

FIG. 6 shows the general encapsulation model for the inventive frames. In the frame 601 there are VC encapsulation header 603, This header is optional. Then in the inventive frame there are VC label, that indicates the respective virtual circuit. Then, frame 607 indicates the tunnel label.

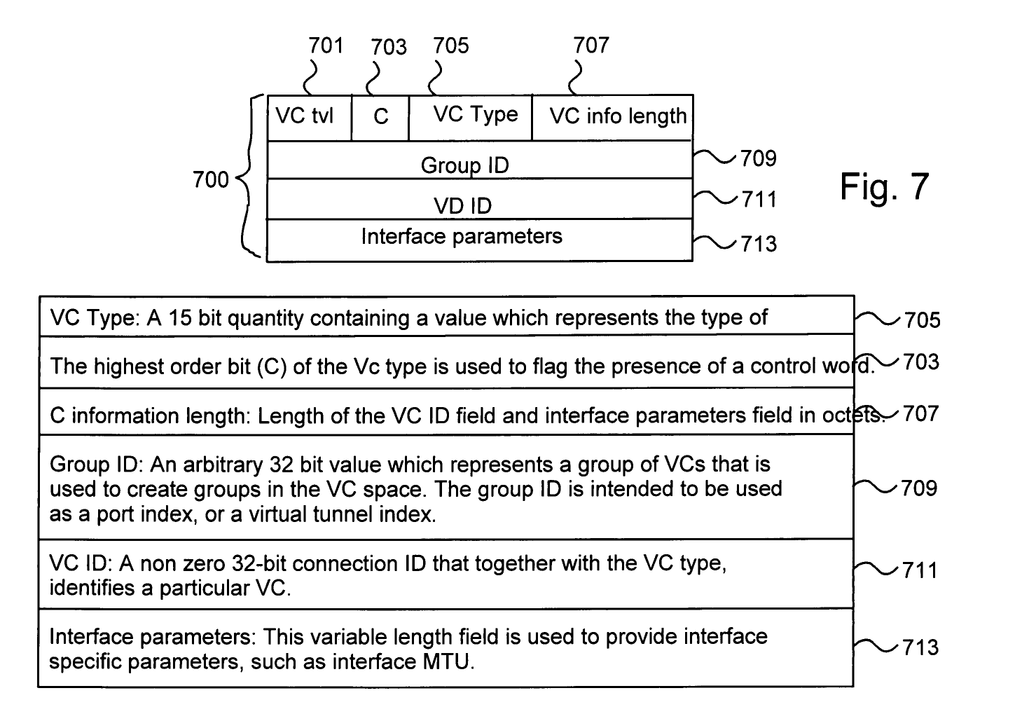

As mentioned above, the MPLS was originally developed carry only IP traffic and therefore FEC specification has concerned only IP packets. For layer 2 frames new FEC is needed. That is specified in draft IETF, draft-martini-12circuit-encap-mpls-03.txt, July 2001 and shown in FIG. 7.

The VC label (605 in FIG. 6) must always be at the bottom of the label stack and the tunnel label (607 in FIG. 6), if present, must be immediately above the VC label. If needed additional labels can be pushed on the stack when packet travels across the network. If peering MPLS nodes are directly adjacent to Label Switch Routers later LSRs, then it may not be necessary to use a tunnel label at all.

FIG. 7 shows the frame structure of the inventive frame. In the frame 700 VC Type field 705 shows a 15-bit quantity containing a value, which represents the type of VC. The field 703 contains the highest order bit (C) of the VC type. This is used to flag the presence of a control word. Field 707 contains VC information length. This means the length of the VC ID field and the interface parameters field in octets. The field group ID field 709 shows an arbitrary 32 bit value which represents a group of VCs that is used to create groups in the VC space. The group ID 709 is intended to be used as a port index, or a virtual tunnel index. The VC ID 711 contains a non zero 32-bit connection ID that together with the VC type, identifies a particular VC. Interface parameters 713 is a variable length field that is used to provide interface specific parameters, such as interface MTU.

FIG. 7 shows how virtual channel length value is assigned to identify length of virtual channel identity and Interface parameters field. For MDC traffic Interface parameters are not specified. Thus, VC length field is 4. This discloses the length of VC ID field in octets.

In the following the concept of group identity is clarified within the context of this embodiment of the invention. According to the previously named publication, IETF, draft-martini-12circuit-trans-mpls-07.txt, July 2001, value of Group ID can be freely chosen to identify several virtual circuit identities VC ID belonging to the same group. That is useful in label withdrawal when only Group ID is needed to withdraw number labels between peering LSRs. This invention shows a way to assign same Group ID to all VC IDs between peering LSRs. In mobile IP network architecture implemented in cellular network that would mean that each CAN (Cellular Access Node) has specific Group ID for the peering CAN, which could allow to withdraw all labels from CAN to other. This might be useful with MDC anchoring concept. Alternatively Group ID could be assigned so that VC IDs belonging to real time services would have a same Group ID, which could be usefull with MDC anchoring case.

In the following the concept of virtual channel identifier is clarified. As mentioned in IETF, draft-martini-12circuit-trans-mpls-07.txt, July 2001, VC type and VC ID is used to identify particular service. Therefore, value of VC ID can be freely chosen, but must be same in all CANs. This VC ID together with VC type (=128 as an example) is used to identify MDC frame transport service at each CAN.

The following clarifies the MDC frame distribution over MPLS. In order to carry MDC frames over MPLS, several inventive modifications compared to the solution shown in Document IETF, draft-martini-12circuit-trans-mpls-07.txt, July 2001, must be made. Especially in the inventive solution following issues must be altered:

Firstly MPLS FEC for MDC traffic. This means that in all relevant FEC tables must be furnished with right indication of virtual circuit type. The new indication of the VC type is MDC, i.e. Macro Diversity Combining. This condition can e.g. be denoted by number 128.

Secondly, MDC frame encapsulation is not needed in the new solution according to the invention.

Thirdly, MDC flow identification must be realized in such a way that for the virtual channel identifier is denoted by an User Datagram Protocol port number. Thus virtual channel identity defines the flow of MDC, this means that it defines the actual traffic flow of the mobile station in question.

Finally, VC label and tunnel label distribution. Label distribution will be clarified later in connection with FIG. 9.

In the following the concept of MPLS FEC for MDC traffic is clarified. For MDC traffic new virtual circuit type value needs to be specified. According to the document, IETF, draft-martini-12circuit-trans-mpls-07.txt, July 2001, virtual channel type value could be selected freely from range 128-32767 that are vendor specific values, or alternatively VC type value in range 64-127 could be assigned by IANA, using “First comes first served” policy. In this embodiment vendor specific value 128 is selected as an example. For the realization of MPLS FEC Interface Parameters is not necessarily needed in the embodiment according to the invention.

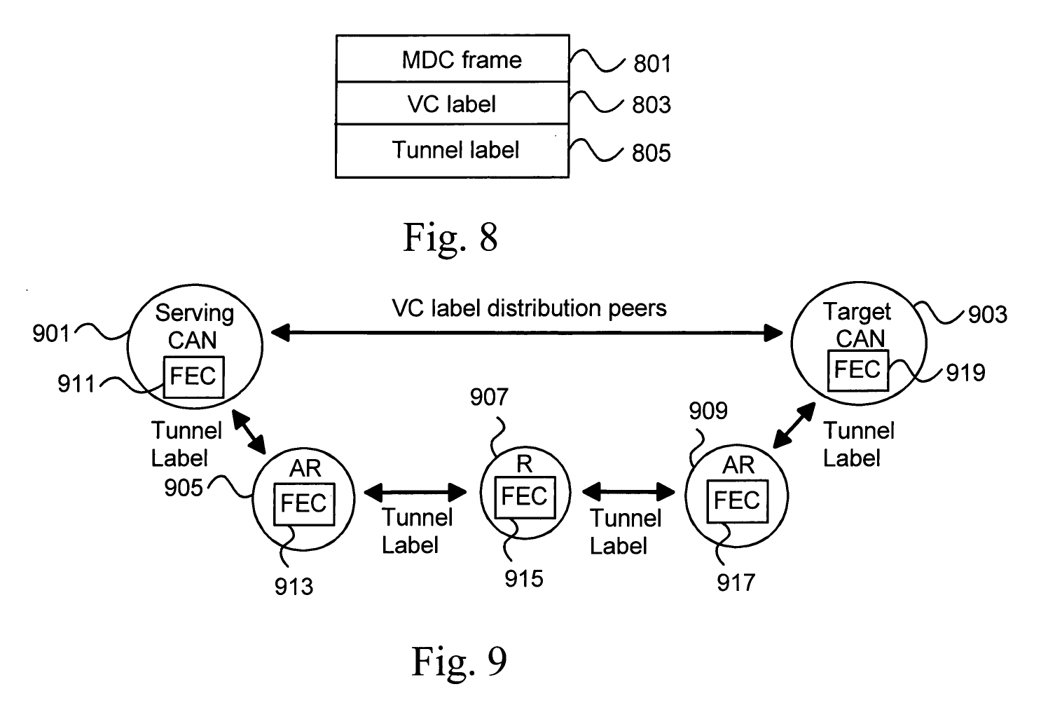

FIG. 8 shows MDC frame 801 encapsulation. VC label 803 and Tunnel label 805 are normal MPLS labels, thus overall overhead is 4+4=8 bytes. This is in radical contrast with the 40+8 bytes required in the prior art embodiment. Thus it is clear that this invention creates considerable benefits compared with the prior art technology. MPLS label fields are mapped according to and thus this encapsulation method has no effect on normal MPLS behaviour. With MDC frames emulated VC encapsulation (control word) is not needed within the realization of this embodiment.

In the following the concept of MDC Flow identification is clarified in context of this invention. MDC flow identification is based on VC label. In other words each MDC flow has own VC label that is multiplexed inside MPLS tunnel by using MPLS stacking. According to the document, IETF, draft-martini-12circuit-trans-mpls-07.txt, July 2001, VC labels must be selected from per-platform label space.

In the following VC label and tunnel label distribution are contemplated. According to draft IETF, draft-martini-12circuit-trans-mpls-07.txt, July 2001 both static and dynamic label distribution is possible. In case of dynamic label distribution in the downstream-unsolicited mode must LDP be used. However, this invention decouples VC label distribution from LDP and proposes to distribute VC label by MDC leg signalling tool, e.g. by Radio Network Subsystem Application Part RNSAP. In this case tunnel label distribution is based on normal MPLS operation i.e. it can be static or dynamic.

In the following the MDC frame transport operation will be clarified in connection with an embodiment of the invention. This section describes MDC frame transport over MPLS in an inventive network. The function of it is based on Cellular Access Node i.e. CAN model. In addition, MDC leg signalling is based on RNSAP as an example, even though other signalling methods could also be used.

In the following FEC set-up will be clarified. The new and inventive MDC FEC must be assigned to each CAN in network set-up phase. Because a CAP entity inside CAN is responsible to map MDC frames to MPLS labels, MDC frame -to- FEC -to- label mapping database must be located to a Cellular Access Point CAP entity.

The VC type and VC ID values must be same in all MDC FECs in all CANs in order to identify MDC frame transport service. The Group ID number could be assigned as mentioned

FIG. 9 will clarify the concept of label distribution. FIG. 9 shows how serving 901 and target 903 CAN do get the information about IP addresses of each other. In FIG. 9, there are further depicted intermediate network elements AR 905 and AR 909, and R 907. One possibility could be to configure database in each serving 901 CAN said database containing IP addresses of candidate target 903 CANs and their mappings to served Cells.

Between serving 901 CAN and target 903 CAN a connection in the form of MDC leg could be set up using RNSAP or some other protocol. In this invention RNSAP is used as an example. FIG. 9 shows first required label associations for MDC over MPLS transport in.

The MDC leg setup follows following procedure:

1. Serving CAN 901 sends RNSAP message containing its own IP address and VC label to target CAN 903. The VC label send by serving CAN 901 is used to identify MDC frames in uplink direction from target CAN 903 to serving CAN 901.

2. In target CAN 903 serving CAN 901 IP address interpretation depends on which MPLS path creation method is used i.e. whether static MPLS paths or request driven path creation is used:

I. With static MPLS paths serving 901 and target 903 CAN has already established MPLS paths between each other and therefore target CAN is able to check directly from proper FEC-to- label mapping table right label for serving CAN 901 IP address. This label is used as Tunnel label, denoted in the figure.

II. Request driven path selection: Target CAN uses RSVP or LDP to get label for the serving CAN IP address according to normal MPLS procedure. In addition, RSVP and LDP can be used to make resources for the LSP. Generally MDC traffic must be treated as a real time traffic.

3. After defining Tunnel label, target CAN 903 replies with RNSAP message containing VC tunnel label and target CAN 903 IP address.

4. Serving CAN follows procedure 2 to decide Tunnel label towards target CAN. The VC label sent by target CAN is used to identify MDC frames in downlink direction from serving CAN to target CAN.

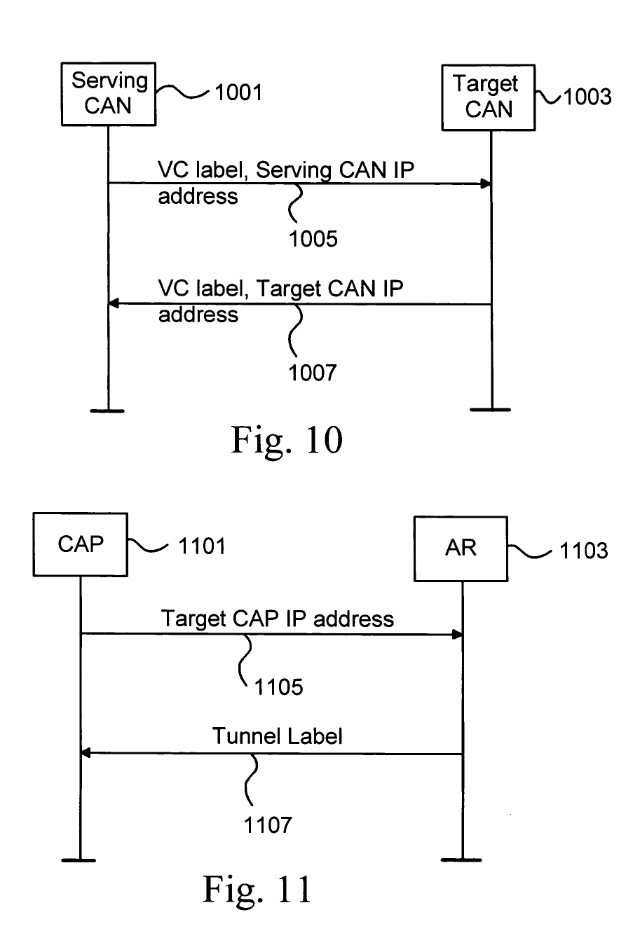

FIG. 10 shows a basic message transfer between serving 1001 and target 1003 CAN nodes. As a result of RNSAP message exchange, bi-directional MPLS tunnel 1005, 1007 is set-up for MDC frame transport. The VC label identifies MDC frame transport session between target 1003 and serving 1001 CANs and Tunnel label is used as on multiplexing layer for all MDC session between target 1003 and serving 1001 CANs.

FIG. 11 elaborates CAN internal operation. The RNSAP message termination points reside in Cellular Access Point CAP entity 1101 of CAN model. Therefore Cellular Access Point CAP 1101 must be able to run MPLS functions or it has to be able to communicate with Access Router (AR) 1103, which must be MPLS capable, in order to infer proper mapping between target CAN IP address 1105 and Tunnel label 1107.

In case the CAP entity 1101 is able to run MPLS, it is able to carry all operations by itself without help of AR 1103. The AR 1103 must perform normal Label Switch Router (LSR) operations to forward packets towards target CAN (1003, FIG. 10).

If Cellular Access Point CAP 1101 is not able to run MPLS, it must communicate with AR 1103. In order to infer mapping between target CAN and Tunnel label 1107, Cellular Access Point CAP 1101 must send request message to AR that contains target CAN (1003, FIG. 10), IP address 1105. The AR 1103 must reply with Tunnel label value. If dynamic MPLS path is used, AR 1103 must first perform LDP/RSVP signalling in order to get Tunnel label. Signalling between Cellular Access Point CAP 1101 and AR 1103 could be utilizing some proprietary protocol.

Regarless whether Cellular Access Point CAP 1101 is MPLS capable or not, CAP 1101 must contain MDC frame -to- FEC -to- VC label database in order to identify MDC frames belonging to particular session.

In CAN model AR and CAP entities are connected to each other by L2 switch. Switches perform only Level 2 switching and therefore switches examine the destination MAC addresses of packets; not the labels. After examining the addresses, they forward the packets to the base. Transporting Labelled Packets over LAN Media Exactly one labelled packet is carried in each frame. The label stack entries immediately precede the payload header, and follow any data link layer headers, including, e.g., any 802.1Q headers that may exist. The ethertype value 8847 hex is used to indicate that a frame is carrying an MPLS unicast packet.

Thus, in case of MDC frames, AR and CAP mark Ethernet headers with value 8847 in order to identify MPLS encapsulated packet instead of IP encapsulated packet between each other.

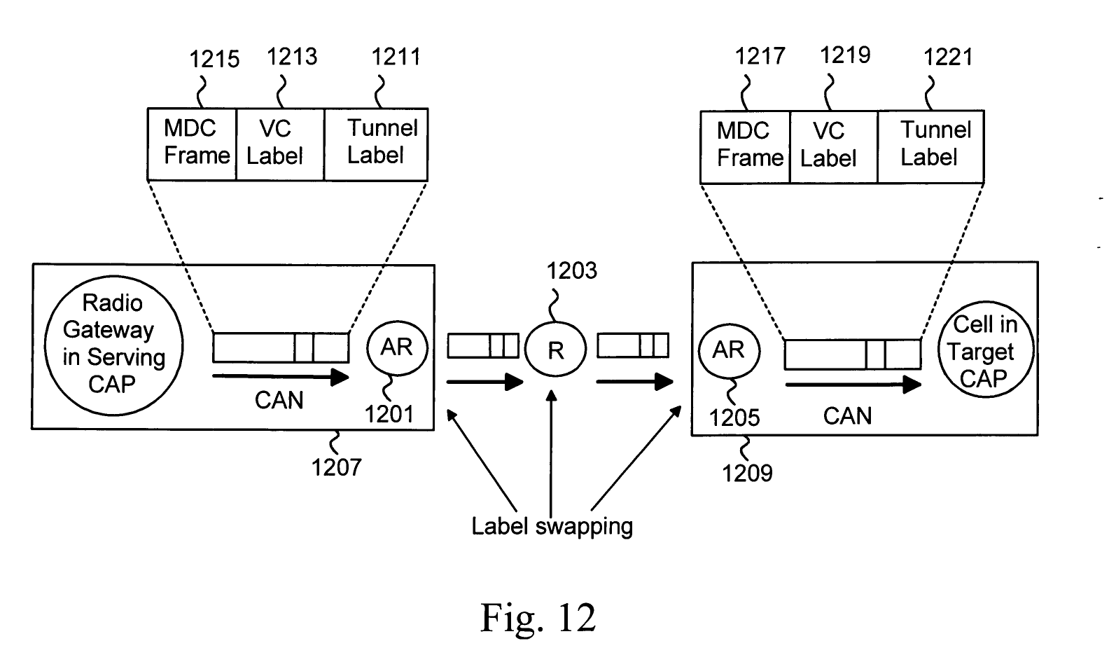

FIG. 12 shows a general overview of MDC transport over MPLS in a cellular network comprising mobile IP architecture. This architecture can be implemented in other networks, like IP based RAN or UTRAN.

In the embodiment shown in FIG. 12 there is so called label-swapping procedure shown. In this contemplation in the first node 1207 there are serving Cellular Access Point CAP which contains an Access Router AR 1201. A next target Cellular Access Point CAP 1209 is a latter node in the network. Between these access edge routers there can be one or several intermediate routers R 1203.

The function of this kind of arrangement is the following. First the Cellular Access Node 1207 reads the tunnel label 1211 from target CAP IP prefix to a tunnel label database. Then VC label 1213 and Tunnel label 1211 are pushed in front of the MDC frames. After this the packet is sent to Access Router 1201.

The packet then moves through one or several routers R 1203. It finally arrives to the edge access node CAN 1209. There the tunnel label 1221 is removed and the right MDC session is read from VC label 1219.

The best mode of implementation of the invention can be used in IP BTS and RNGW in IPRAN and CAN in cellular mobile IP network, when MPLS is implemented, with additional FEC element as described in this invention.

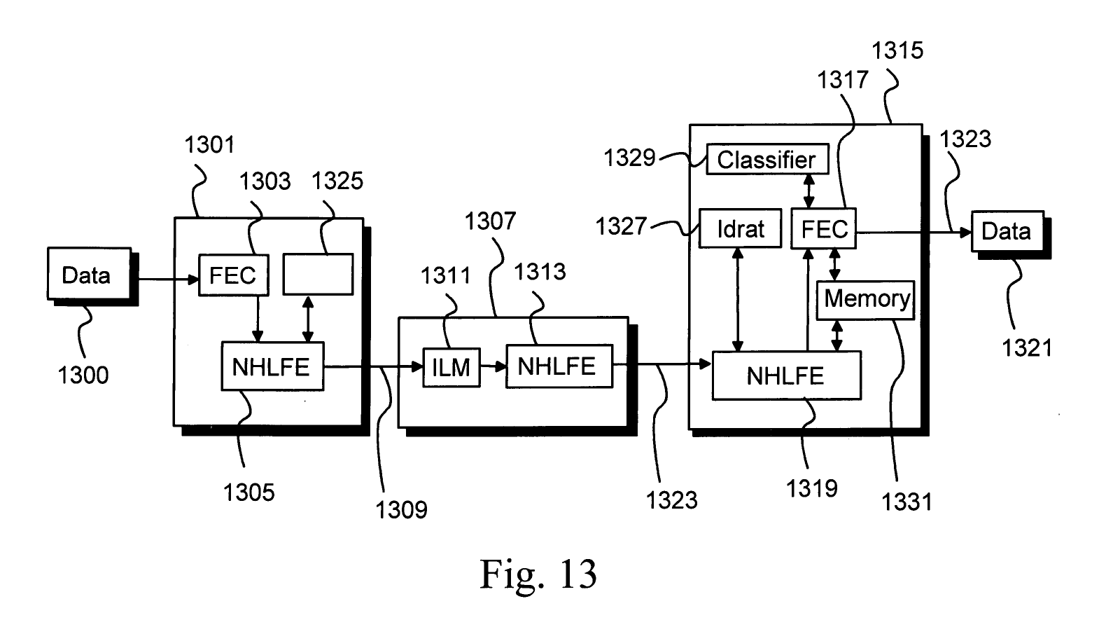

FIG. 13 shows a block diagram of the inventive communications system. This figure shows communications system for forwarding data units. The system comprises one or more ingress router 1301 containing a Forwarding Equivalence Class table FEC 1303 that contains mapping information. The ingress router 1301 further contains an assigning means 1305 for assigning a first label and a second label on said data unit 1300. The assigning means can also be called next hop label Forwarding Entry NHLFE 1305. The ingress router 1301 further contains forwarding means 1325 for sending said data units 1300 in to said mobile communications system.

The communications system depicted in FIG. 13 further comprises one or more intermediate routers 1307 said intermediate routers 1307 comprising forwarding means, which is composed of e.g. Incoming Label Map ILM 1311 and next hop label Forwarding Entry NHLFE, 1313, for forwarding data units within said communications system based on said first label.

The communications system for forwarding data units further comprises one or more egress routers 1315 containing a Forwarding Equivalence Class table FEC 1317 containing mapping information, and a second assigning means 1319 for assigning said second label based on the information in said Forwarding Equivalence Class table FEC 1317 in said ingress router 1315. This second assigning means 1319 is a next hop label forwarding entry. The egress router 1315 further comprises an identifier 1327 for identifying said data units in said egress routers based on information on said Forwarding Equivalence Class table FEC and said second label.

This innovative communications system (FIG. 13) further comprises a classifier 1329 for creating Forwarding Equivalence Class for radio access network specific data units. This innovative communications system (FIG. 13) further comprises a memory 1331 for storing information about said Forwarding Equivalence Class in said Forwarding Equivalence class table FEC 1317.

The invention is not restricted to the examples of its embodiments described above, but many variations are possible within the scope of the inventive idea defined by the claims.

### REFERENCES

[T_L2] IETF, draft-martini-12circuit-trans-mpls-07.txt, July 2001
[E_L2] IETF, draft-martini-12circuit-encap-mpls-03.txt, July 2001
   ANNEX: List of Acronyms Used
ATM—Asynchronous Transfer Mode
AR—Access Router
AuC—Authentication Center
BG—Border Gateway
BSSGP—Base Station System GPRS Protocol
BSC—Base Station Controller
BTS—Base Transceiver Station
CAN—Cellular Access Node
CAP—Cellular Access Point
CN—Core Network
CR—Constraint-based Routing
EIR—Equipment Information Register
FDMA—Frequency Division Multiple Access
FEC—Forwarding Equivalency Classes
GGSN—Gateway GPRS Support Node
GMSC—Gateway Mobile Switching Center
GPRS—General Packet Radio Service
GSM—Global System for Mobile Communication
GSN—GPRS Support Node
GTP—GPRS Tunnelling Protocol
GW—Gateway
IETF—Internet Engineering Task Force
IP—Internet Protocol
IP RAN—Internet Protocol Radio Access Network
HLR—Home Location Register
LDP—Label Distribution Protocol
LSP—Label Switched Path
LSR—Label Switch Router
MAC—Media Access Control
MDC—Macro Diversity Combining
MPLS—Multiprotocol Label Switching
MS/MT—Mobile station or terminal
MSC—Mobile Switching Center
NHLFE—Next Hop Label Forwarding Entry
N-PDU—Network Protocol Data Unit
NSS—Network Subsystem
OSPF—Open Shortest Path First
PDN—Public Data Network
PDCP—Packet Data Convergence Protocol
PDP—Packet Data Protocol
PLMN—Public Land Mobile Network
PSTN—Public Switched Telecommunications Network
RANAP—Radio Access Network Application Part
RLC—Radio Link Control
RNAS—Radio Network Access Server
RNC—Radio Network Controller
RNGW—Radio Network Gateway
RNSAP—Radio Network Subsystem Application Pact
RSVP—Resource Reservation Protocol
RTP—Real Time Protocol
SGSN—Serving GPRS Support Node
SNDCP—Sub-Network Dependent Convergence Protocol
TCP—Transmission Control Protocol
TDMA—Time Division Multiple Access
TEI—Tunnel Endpoint Identifier
TTL—Time To Live
UDP—User Datagram Protocol
UIM—User Identity Module (UMTS)
UMTS—Universal Mobile Telecommunications System
UTRAN—UMTS Terrestrial Radio Access Network
VC—Virtual Circuit
Virtual Circuit capsulation
VLR—Visitor Location Register

1. A method for forwarding data units (FIG. 8) in a communications system, the system comprising:
one or more ingress routers (901;1301) capable of forwarding data units and containing a Forwarding Equivalence Class table (911) said Forwarding Equivalence Class table (911) containing mapping information,
one or more intermediate routers (905, 907, 909; 1307) capable of forwarding data units,
one or more egress routers (903;1315) capable of forwarding data and containing a Forwarding Equivalence Class table (919) said Forwarding Equivalence Class table (919) containing mapping information,
said method comprising the steps of:
said one or more ingress router (901;1301) assigning a first label (FIG. 12, 1213) on said data unit and a second label (FIG. 12, 1211) on said data unit based on said mapping information,
said one or more ingress router (901;1301) sending said data unit in to said egress router via said one or more intermediate router (905, 907, 909),
said one or more egress router (903; 1315) receiving said data unit,
said one or more egress router (903; 1315) identifying said received data unit based on said mapping information on said Forwarding Equivalence Class table (919) and based on said second label (FIG. 12, 1211),
characterized in that, said method further comprises the steps of:
creating (1329) a Forwarding Equivalence Class for radio access network specific data units; and
storing (1331) information about said Forwarding Equivalence Class in said Forwarding Equivalence class table (FEC).

2. The method according to claim 1 characterized in that, said radio access network specific data units (1300) are Macro Diversity Combining data units (801).

3. The method according to claim 1, characterized in that, said radio access network specific data units (1300) are GPRS tunneling protocol data units.

4. A method according to claim 1, characterized in that, said method further comprises the steps of
providing said Forwarding Equivalence Class tables (911, 913, 915, 917, 919) with a Virtual Channel type indicator (VC type ID) and a Virtual Channel identifier (VC ID) and
utilizing said Virtual Channel type indicator (VC type ID) and said Virtual Channel identifier to identify said Macro Diversity combining and/or said GPRS tunneling protocol data units in said ingress (901) and egress (903) routers.

5. The method according to claim 1, characterized in that, said method comprises the steps of
utilizing MPLS protocol in said communication system,
said first label being a tunnel label (1211) of a MPLS tunnel defined in said MPLS protocol, and
said one (905) or more intermediate router forwarding said data unit in to said one ore more egress router (903) based on said first label.

6. The method according to claim 5, characterized in that, said method comprises the step of
said intermediate router (905) swapping (FIG. 12) said first labels according to said MPLS protocol.

7. The method according to claim 1, characterized in that said method comprises the steps of
Distributing (FIG. 9) said second label to said ingress (901) and said egress routers (903) using radio network signaling protocol, and
storing said second label in to said Forwarding Equivalence Class table (911, 913, 915, 917, 919).

8. The method according to claim 7, characterized in that, said method comprises the step of
said radio network signalling protocol being one of the following protocols
a) RANAP-protocol
b) RNSAP-protocol.

9. A communications system for forwarding data units, the system comprising:
one or more ingress router (901; 1301) containing
a Forwarding Equivalence Class table (FEC, 1303) containing mapping information,
an assigning means (1305) for assigning a first label and a second label on a data unit 1300, and
forwarding means (1325) for sending said data 1300 units in to said mobile communications system,
one or more intermediate routers (1307) said intermediate routers comprising
forwarding means for (1311, 1313) forwarding data units (1300) within said communications system based on said first label,
one or more egress routers (1315) containing
a Forwarding Equivalence Class table (FEC, 1317) containing mapping information, and
a second assigning means (1319) for assigning said second label based on the information in said Forwarding Equivalence Class table (FEC, 1317) in said egress router (1315),
an identifying means (1327) for identifying said data units (1300) in said egress routers based on information on said Forwarding Equivalence Class table (FEC, 1317) and said second labels,
characterized in that, said communications system further comprises:
a classifier (1329) for creating Forwarding Equivalence Class for radio access network specific data units; and
a memory (1331) for storing information about said Forwarding Equivalence Class in said Forwarding Equivalence class tables (FEC).

10. A mobile communications system according to claim 9, characterized in that, said radio access network specific data units (1300) are Macro Diversity Combining data units.

11. A mobile communications system according to claim 9, characterized in that, said radio access network specific data units (1300) are GPRS tunneling protocol data units.
